(19) United States
(12) Patent Application Publication
(10) Pub. No.: US 2008/0265461 A1
(43) Pub. Date: Oct. 30, 2008

(54) Method and Apparatus for Blow-Molding Containers with In-Mold Film Having RFID Tag Fused Thereto

(75) Inventors: Robert Freund, Dayton, OH (US); Doug Deluke, Bridgeton, NJ (US); Garrett Hager, Lancaster, PA (US)

Correspondence Address: MILLER, MATTHIAS & HULL, ONE NORTH FRANKLIN STREET, SUITE 2350, CHICAGO, IL, 60606, US

(73) Assignee: Alcan Global Pharmaceutical Packaging Inc., Pennsauken, NJ (US)

(21) Appl. No.: 12/109,876

(22) Filed: Apr. 25, 2008

Related U.S. Application Data
(60) Provisional application No. 60/914,495, filed on Apr. 27, 2007.

(51) Int. Cl. B29C 45/14

(52) U.S. Cl. 264/272.15; 425/517

(57) ABSTRACT

An apparatus and method for manufacturing plastic containers having RFID tags embedded therein is disclosed. The bottles are manufactured using a blow-molding technique wherein an in-mold film having an RFID tag embedded therein is positioned or placed against the parison immediately prior to the blow mold being closed and the pressurized air being used to inflate the parison. The resulting container thus has an RFID tag fused thereto to allow for tracking and tracing of the container after manufacture, as well as providing a mechanism by which the authenticity of the bottle can be verified.

### CROSS-REFERENCE TO RELATED APPLICATION

This application is a non-provisional application claiming priority under 35 USC 119(e) to U.S. Provisional Patent Application No. 60/914,495 filed on Apr. 27, 2007.

### FIELD OF THE DISCLOSURE

The present disclosure is generally related to methods of molding plastic components and, more particularly, is related to methods of injection blow-molding bottles having RFID tags incorporated therein.

### BACKGROUND OF THE DISCLOSURE

In the modern market-place, it is often desirable to manufacture products such as bottles and containers which can be easily tracked from the moment they are manufactured, to the distribution center where they are temporarily stored, to the retail facility at which they are sold, and ultimately to the home of the consumer or business. Many devices have been created over the years to allow for that objective to at least be partially obtained. For example, most commercial products now are provided with a universal product code (UPC) or other form of bar code which is an electronic signature capable of being scanned by an optical reader. The bar code has a unique signature for the specific type of product to which it is assigned but has limited ability to track an individual product within a category of products. In addition, the bar code must be specifically scanned by the optical reader, and cannot be passively monitored from a distance.

Accordingly, the introduction of radio frequency identification (RFID) tags has become wide spread with many modern products. RFID tags can be either active or passive with the passive form being the most desirable given their relatively low expense. With a passive RFID tag, an integrated chip is provided with a simple antenna but without any dedicated power source. The circuit is such that upon exposure to a radio frequency wave from a transmitter or transponder, a sufficient level of current is induced in the chip so as to power up and in turn transmit its unique radio frequency identification code back to the receiver or transponder. The chip is often manufactured using lithography or other advanced printed techniques as opposed to being a pre-fabricated chip on a silicone wafer as is conventionally known. Such chips can be as small as 0.15 mm×0.15 mm in area and thinner than a conventional sheet of paper. Accordingly, in addition to the aforementioned benefits of bar codes, they also provide the benefit of taking up relatively little or no space on the object to which they are attached.

While the incorporation of RFID tags has become common place on many retail products including electronics, clothing tags, automobiles and the like, one difficulty which currently exists is incorporation of such tags in molded products. In particular, in the manufacture of hollow containers or bottles, the incorporation of such tags is particularly problematic in that such bottles are mass produced by way of injection blow-molding for example, which has to be done at a high speed under extremely high temperatures, and at relatively low costs. Methods of using adhesives to attach an RFID tag to such containers during the manufacturing process may exist. However, use of such adhesives requires additional costs and materials, and significantly slows down the manufacturing process. One option would be to incorporate the RFID onto the bottle post-manufacturing, but this by its very nature is also relatively slow, relatively expensive, and less than optimal aesthetically.

One promising technology involves the manufacture of laminates or films with RFID tags incorporated directly into the film as it is manufactured. An example of such a film is disclosed in U.S. Pat. No. 7,166,249, the disclosure of which is expressly incorporated herein by reference. However, techniques and apparatus still need to be provided so as to efficiently mold such a film to a bottle while maintaining the speed and low cost of conventional injection blow-molding techniques.

### SUMMARY OF THE DISCLOSURE

In accordance with one aspect of the disclosure, a method of molding a container having an RFID tag incorporated therein is disclosed which comprises the steps of molding a heated parison; positioning the heated parison between halves of a mold having a cavity in the form of the desired container; placing an in-mold film in contact with the heated parison, the in-mold film having the RFID tag incorporated therein; forcing the mold halves together; inflating the heated parison to form the container; and removing the container from the mold with the in-mold film and RFID tag fused thereto.

In accordance with another aspect of the disclosure, a method of molding a container having an RFID tag incorporated therein is disclosed which comprises the steps of injection molding a heated parison around a mandrel; positioning the heated parison and mandrel between halves of a mold having a cavity in the form of the desired container; placing an in-mold film into direct contact with the heated parison, the in-mold film having at least four layers and the RFID tag incorporated therein; forcing the mold halves together; inflating the heated parison to form the container; and removing the container from the mold with the in-mold film and RFID tag fused thereto.

In accordance with another aspect of the disclosure, an apparatus for molding a container having an RFID tag incorporated therein is disclosed which comprises a turn-table having a plurality of mandrels outwardly extending therefrom, the turn-table being rotatable in increments such that the mandrels sequentially move along a linear pathway; and a plurality of stations positioned along the pathway such that each station is in close proximity to at least one mandrel at any one time, the plurality of stations including at least a first station having a parison mold for injection molding a parison onto the mandrel, a second station for positioning an in-mold film having the RFID tag therein directly onto the parison and having a blow mold for blow-molding the container, a third station for removing the container from the mandrel, and a fourth station for conditioning and preparing the mandrel for molding a new parison thereon.

These and other aspects and features of the disclosure will become more apparent upon reading the following description when taken in conjunction with the following drawings.

### BRIEF DESCRIPTION OF THE DRAWINGS

FIG. 1 is a flow chart depicting a sample series of steps which may be practiced by the teachings of the present disclosure;

FIG. 2 is a schematic representation of a sample machine which may be used to produce containers according to the method of the present disclosure;

FIG. 3 is a schematic representation of an injection molding step according to the present disclosure;

FIG. 4 is a schematic representation of the blow-molding step according to the present disclosure;

FIG. 5 is a schematic representation of a container stripping step according to the present disclosure;

FIG. 6 is a perspective view of a container with integrated RFID tag according to the teachings of the disclosure; and

FIG. 7 is a cross-sectional view of the container film taken along line 7-7 of FIG. 6.

While the present disclosure is susceptible to various modifications and alternative constructions, certain illustrative embodiments thereof have been shown in the drawings and will be described below in detail. It should be understood, however, that there is no intention to limit the present invention to the specific forms disclosed, but on the contrary, the intention is to cover all modifications, alternative constructions, and equivalents falling within the spirit and scope of the present invention.

### DETAILED DESCRIPTION OF THE DISCLOSURE

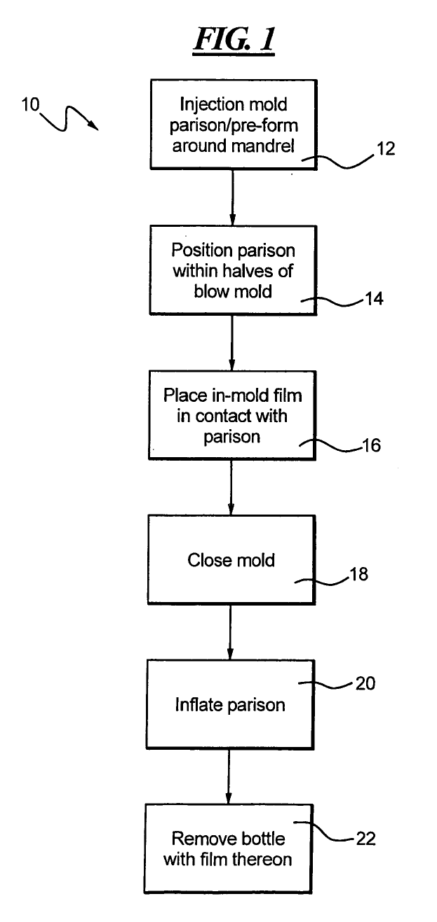

Referring now to the drawings and, with specific reference to FIG. 1, a flow chart depicting a sample sequence of steps which can be practiced according to the teachings of the present disclosure is provided. While the following steps and apparatus will be described in conjunction with an injection blow-molding process, it should be understood that the teachings of the disclosure may be practiced using other forms of blow-molding including extrusion blow-molding, stretch blow-molding, and the like.

Referring now with specific reference to FIG. 1, a process 10 according to an injection blow-molding procedure may include a first step 12 to injection mold a pre-form, or parison, used to eventually form a container. The parison may be hollow and substantially cylindrical having the general dimension of the neck of the bottle or container to be formed. The parison may be injection molded using conventional steps such as grinding pelletized plastic through a screw conveyor so as to heat and melt the pellets into a liquid form. The heated liquid plastic may then be injected under pressure into the injection mold to create a heated parison. Once complete, the heated parison may be removed from the injection mold for further processing.

The heated parison formed in the first step 12 may be positioned within halves of a blow mold in a subsequent step 14 of the process 10 of FIG. 1. Prior to closing the halves of the blow mold, an in-mold film having an RFID tag embedded therein may be placed into contact with the heated parison in a third step 16. Given the tacky nature of the heated parison, the film may be temporarily adhered directed to the parison. This option avoids the use of a separate adhesive, which may require significant time and additional expenses to implement. Moreover, the sticky and tacky nature of the parison ensures proper positioning of the film and RFID tag while maintaining the structural integrity of the parison. Alternatively, the film and the RFID tag may be positioned within the blow mold which upon closing may force the film into contact with the parison.

As indicated in a next step 18 of the process 10 of FIG. 1, the halves of the blow mold may be closed under significant pressure levels using hydraulic cylinders, or the like, so as to form a substantially sealed cavity in which a container may be formed. Once the mold is so closed, pressurized air may be injected into the hollow interior of the parison so as to inflate the parison in an inflation step 20. This inflation may cause the parison to move radially outwardly until it engages the inner surface of the closed blow mold thereby assuming the shape of the desired container. As the mold is maintained at a relatively low temperature, the container may quickly solidify and cool itself, allowing for it to be removed from the mold in a removal step 22, shortly after the inflation step 20. As the container so formed is provided with an RFID tag fused thereto by way of the film, the resulting container may easily be tracked from the moment of creation, to the point of sale, to the time of disposal with substantially little change in the speed with which the containers may be manufactured or the resulting cost as well.

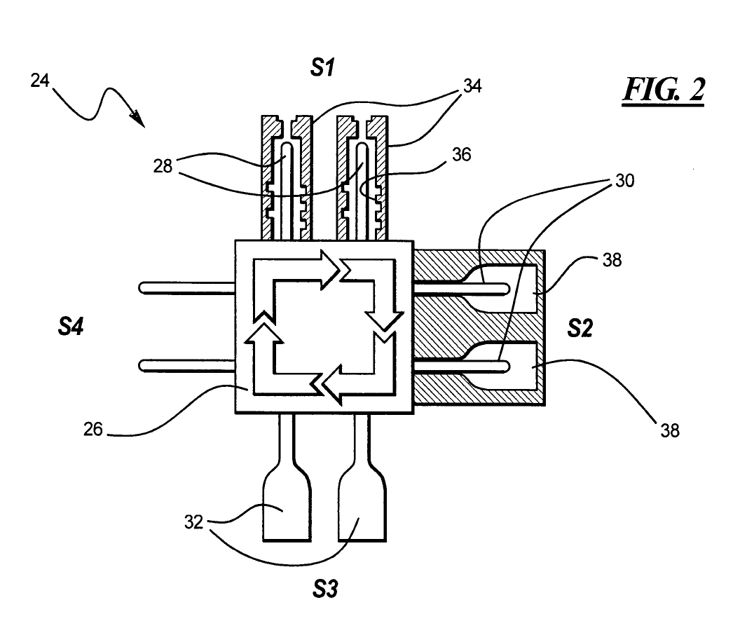

Tools or machines used to practice the pending disclosure may be provided in many forms with the machine 24 depicted in FIG. 2 being but one example. As indicated therein, the machine 24 may be provided with a turn-table 26 from which one or more core rods or mandrels 28 outwardly extend. The turn-table 26 may be rotatable so as to sequentially rotate the mandrels 28 through a series of stations, such as stations S1-S4, located along a pathway. Each of the stations S1-S4 may execute a different step, or set of steps, of a process, such as the blow-molding process 10 of FIG. 1. During use, the turn-table 26 may sequentially rotate the mandrels 28 through each of the stations S1-S4 to eventually form a container at the end of one complete revolution or cycle. More specifically, the turn-table 26 of FIG. 2 may undergo four sequential rotations of 90 degrees each to complete one cycle and to completely form one set of containers having RFID tags fused thereto. Alternatively, more or fewer stations may be arranged around the turn-table 26, in which case the turn-table 26 may sequentially step through smaller or larger rotations, respectively, to complete one revolution. It is also to be understood that as opposed to the rotational turn-table 26 arrangement, other machines and assemblies may be used wherein such stations are provided at discrete locations along a linear pathway of an assembly process.

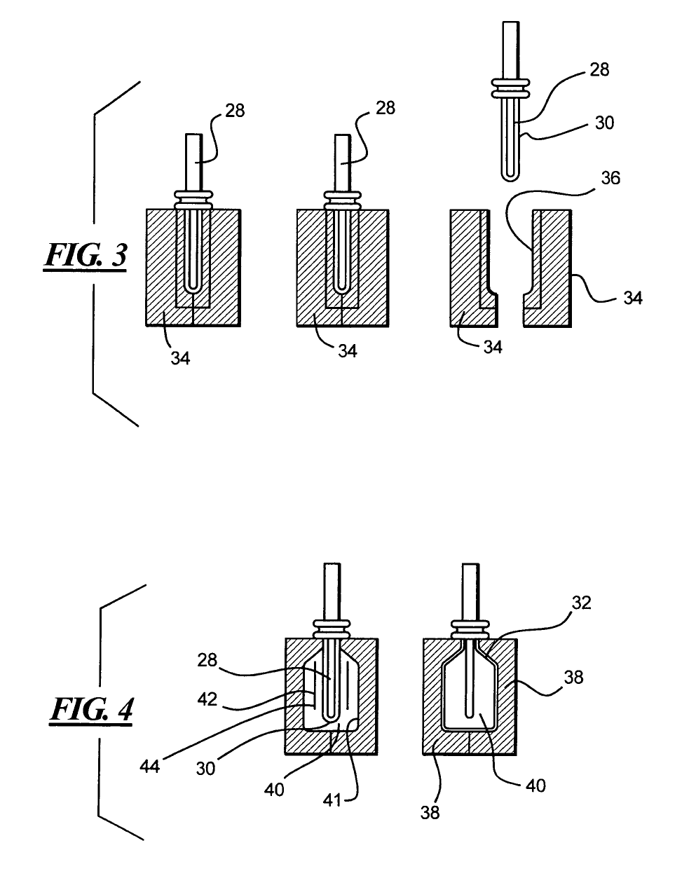

Still referring to FIG. 2, an exemplary first station S1 may perform the first step 12 of injection molding a parison 30 used to eventually form a container 32. Specifically, the first station S1 may provide parison molds 34 positioned around its respective central core or mandrel 28, as also shown in more detail in FIG. 3. In addition to allowing for the hollow cylindrical form of the parison 30, the mandrel 28 may be hollow as well so as to provide a conduit for the introduction of pressurized air for use in the blowing step referenced later herein. The parison molds 34 may provide a space or cavity 36 in the shape of the desired parison 30. More specifically, the desired shape may have a substantially cylindrical appearance but for a neck having a size substantially similar to the resulting neck of the desired bottle or container 32. The parison molds 34 may be conventionally provided in mating or clam shell halves which when secured together under significant pressure form a substantially sealed cavity 36 adapted for the injection of liquid plastic, as is commonly known in the injection molding field. Subsequently, the liquid plastic may be injected into the cavity 36 between the mandrel 28 and the parison molds 34 to form the parison 30. The parison molds 34 may then be removed from the resulting parison 30 situated about the mandrel 28. The parison 30 may be held at a relatively elevated temperature so as to maintain its tackiness, as well as malleable form.

While the parison 30 is still heated and malleable, it may be advanced into a second station S2 where the subsequent steps 14, 16, 18 and 20 of FIG. 1 may be executed. Specifically, the turn-table 26 may rotate 90 degrees to advance the mandrel 28 and its heated parison 30 into the second station S2 and position the parison 30 within halves of a blow mold 38, as shown in FIG. 4. The blow mold 38 may be formed so as to include an internal cavity 40 and the substantial shape of the desired container 32. In any such embodiment, the parison 30 may be molded over the mandrel 28 such that the parison 30 is positionable directly within the halves of a blow mold 38 once formed, so as to maintain the heated nature of the parison 30 until the blowing step 20 of FIG. 1 is completed.

After the heated parison 30 is formed about the mandrel 28 and positioned within the halves of the blow mold 38, an in-mold film 42 having an RFID tag 44 embedded therein may be placed into contact with the heated parison 30 prior to closing the blow mold 38, as indicated by the third step 16 of FIG. 1. Given the heated and tacky nature of the parison 30, the in-mold film 42 may be temporarily adhered directed to the parison 30. As emphasized above, this option avoids the use of a separate adhesive, which may require significant time and additional expenses to implement. Moreover, the sticky and tacky nature of the parison 30 ensures proper positioning of the in-mold film 42 and the RFID tag 44 while maintaining the structural integrity of the parison 30. Alternatively, the in-mold film 42 and the RFID tag 44 may be positioned within the cavity 40 of the blow mold 38, which upon closing may force the in-mold film 42 into contact with the parison 30. In either event, measures may be taken to ensure and inspect that the in-mold film 42 is properly positioned relative to the parison 30 prior to the blow mold 38 being closed.

Once the in-mold film 42 containing the RFID tag 44 is placed in contact with the parison 30, the blow mold halves 38 may finally be closed as indicated in the mold closing step 18 of FIG. 1. The second station S2 may close the halves of the blow mold 38 under significant pressure levels using hydraulic cylinders, or the like, so as to form a substantially sealed cavity 40 in which the container 32 may be formed. Once the blow mold 38 is so closed, pressurized air may be injected into the mandrel 28 and the hollow interior of the parison 30 so as to inflate the parison 30, as indicated by the inflation step 20 of FIG. 1. This inflation may cause the parison 30 to move radially outwardly until it engages the inner surface 41 of the cavity 40, thereby assuming the shape of the desired container 32, as further indicated by FIG. 4. The blow mold halves 38 may be maintained at a lower temperature so as to cause the plastic of the container 32 to immediately begin cooling after the inflation step 20.

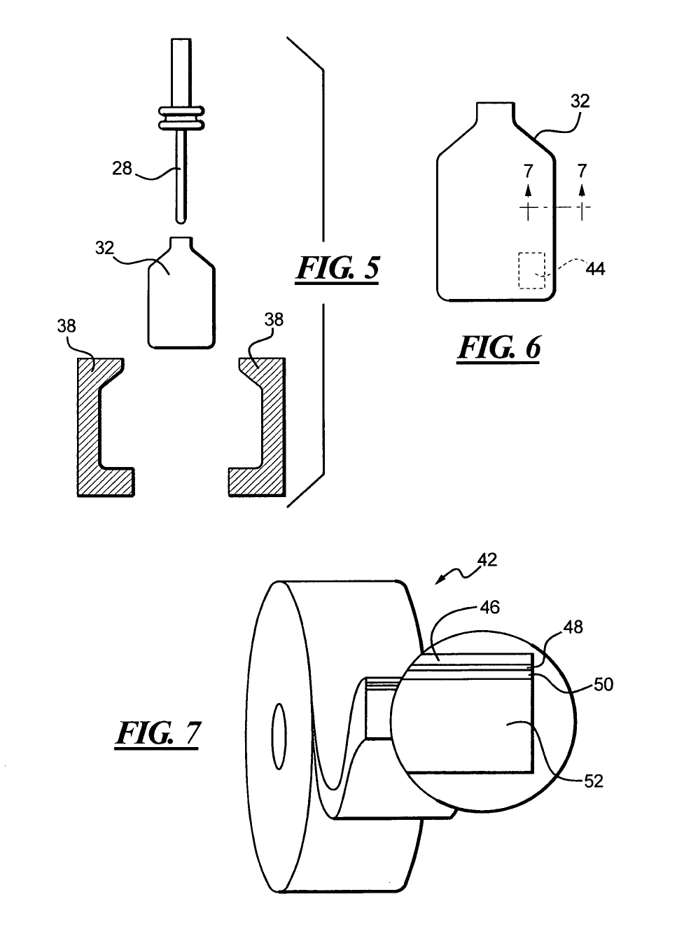

With the blow mold halves 38 still closed about the container 32, the turn-table 26 may rotate another 90 degrees to position the container 32 and blow mold halves 38 into a third station S3. Once so positioned, the blow mold halves 38 may be removed from the container 32 as shown in FIG. 5 to expose the container 32. Alternatively, the blow mold halves 38 may be removed from the container 32 in the second station S2 prior to entering the third station S3. In either event, once the container 32 is substantially cooled, the container 32 may be stripped from the mandrel 28 during the removal step 22 as indicated in FIG. 1. As shown in FIG. 6, the resulting container 32 may have the in-mold film 42 and RFID tag 44 fused thereto. It is to be understood that the RFID tag 44 in so doing can be located at any position on the exterior surface of the container 32, including but not limited to, the side walls and bottom.

Once the container 32 has been removed from the mandrel 28, the turn-table 26 of FIG. 2 may then rotate another 90 degrees to position the mandrel 28 into a fourth station S4. The fourth station S4 may simply condition and prepare the mandrel 28 for reentry back into the first station S1 so as to repeat the blow-molding process 10 of FIG. 1.

Finally, with respect to FIG. 7, a cross-section is provided of the in-mold film 42. The in-mold film 42 depicted in FIG. 7 may include at least four layers having a top layer 46 in the form of a high gloss and durable material such as urethane. The second layer underneath the top layer 46 may be the security layer 48. The security layer 48 may include not only the RFID tag 44 but may also include custom logos or symbols which are invisible to the unaided eye and only made visible through the use of ultraviolet or infrared light sources. In an underlying graphics layer 50, color and other marketing materials and information desired by the ultimate user of the container 32 may be provided. Finally, underneath the graphics layer 50 may be a fusion layer 52 which may be manufactured so as to easily fuse with the material from which the container 32 is manufactured. A number of different polymers are suitable for injection blow-molding as is readily understood in the art. Those polymers include, but are not limited to, polypropylene, polyethylene, polyethylene-terephthalate, polystyrene, polycarbonate, ABS, polyvinylchloride, nylon, low density polyethylene, and high density polyethylene.

Based on the foregoing, it can be seen that a new method and apparatus for manufacturing plastic containers having an RFID tag embedded or fused directly thereto is disclosed. Not only is the RFID tag fused thereto, but it may be manufactured at relatively the same speeds and cost levels as with conventional injection blow-molding techniques. By including the RFID tag into such a container, the container may be tracked and traced from the moment of manufacture to the moment of sale and even the moment of discarding for recycling purposes. In addition, the products may be traced in the event of theft or loss. The RFID tag may also allow manufacturers and consumers to verify the authenticity of the product thereby providing a deterrent against counterfeit products. This may be of particular importance in the health care industry wherein consumers need to be able to rely upon authenticity and safety of the drugs or medicines provided within the container.

What is claimed is:

1. A method of molding a container having an RFID tag therein, comprising the steps of:
molding a heated parison;
positioning the heated parison between halves of a mold having a cavity in the form of the desired container;
placing an in-mold film in contact with the heated parison, the in-mold film having the RFID tag incorporated therein;
forcing the mold halves together;
inflating the heated parison to form the container; and
removing the container from the mold with the in-mold film and RFID tag fused thereto.

2. The method of claim 1, wherein the step of molding the parison is performed by injection molding the heated parison around a mandrel.

3. The method of claim 1, wherein the step of placing an in-mold film in contact with the heated parison does not include adhesives.

4. The method of claim 1, wherein the in-mold film placed in contact with the heated parison includes at least four layers.

5. The method of claim 1, wherein the in-mold film placed in contact with the heated parison includes a urethane layer.

6. The method of claim 1, wherein the in-mold film placed in contact with the heated parison includes a security layer.

7. The method of claim 1, wherein the in-mold film placed in contact with the heated parison includes a graphics layer.

8. The method of claim 1, wherein the in-mold film placed in contact with the heated parison includes a fusion layer.

9. The method of claim 1, wherein the step of forcing the mold halves together is performed by hydraulic cylinders.

10. A method of molding a container having an RFID tag therein, comprising the steps of:
injection molding a heated parison around a mandrel;
positioning the heated parison and mandrel between halves of a mold having a cavity in the form of the desired container;
placing an in-mold film into direct contact with the heated parison, the in-mold film having at least four layers and the RFID tag incorporated therein;
forcing the mold halves together;
inflating the heated parison to form the container; and
removing the container from the mold with the in-mold film and RFID tag fused thereto.

11. The method of claim 10, wherein the step of placing an in-mold film into contact with the heated parison does not include adhesives.

12. The method of claim 10, wherein the in-mold film placed into contact with the heated parison includes a urethane layer.

13. The method of claim 10, wherein the in-mold film placed into contact with the heated parison includes a security layer.

14. The method of claim 10, wherein the in-mold film placed into contact with the heated parison includes a graphics layer.

15. The method of claim 10, wherein the in-mold film placed into contact with the heated parison includes a fusion layer.

16. The method of claim 10, wherein the step of forcing the mold halves together is performed by hydraulic cylinders.

17. An apparatus for molding a container having an RFID tag therein, comprising:
a turn-table having a plurality of mandrels outwardly extending therefrom, the turn-table being rotatable in increments such that the mandrels sequentially move along a linear pathway; and
a plurality of stations positioned along the pathway such that each station is in close proximity to at least one mandrel at any one time, the plurality of stations including at least a first station having a parison mold for injection molding a parison onto the mandrel, a second station for positioning an in-mold film having the RFID tag therein directly onto the parison and having a blow mold for blow-molding the container, a third station for removing the container from the mandrel, and a fourth station for conditioning and preparing the mandrel for molding a new parison thereon.

18. The apparatus of claim 17, wherein the turn-table rotates in increments of 90 degrees.

19. The apparatus of claim 17, wherein the second station further includes hydraulic cylinders for sealing the blow mold.

20. The apparatus of claim 17, wherein the first and second stations are maintained at relatively elevated temperatures
